(19) United States
(12) Patent Application Publication
(10) Pub. No.: US 2015/0067465 A1
(43) Pub. Date: Mar. 5, 2015

(54) HANDWRITTEN DOCUMENT PROCESSING DEVICE, HANDWRITTEN DOCUMENT PROCESSING METHOD, AND HANDWRITTEN DOCUMENT PROCESSING PROGRAM

(71) Applicant: Kabushiki Kaisha Toshiba, Tokyo (JP)

(72) Inventors: Toshiaki NAKASU, Tokyo (JP); Kazunori IMOTO, Kawasaki-shi (JP); Yojiro TONOUCHI, Tokyo (JP); Isao MIHARA, Tokyo (JP)

(21) Appl. No.: 14/340,423

(22) Filed: Jul. 24, 2014

(30) Foreign Application Priority Data
Aug. 30, 2013 (JP) 2013-179845

(51) Int. Cl. G06F 17/24

(52) U.S. Cl. CPC G06F 17/245
USPC 715/228

(57) ABSTRACT

According to one embodiment, a handwritten document processing device includes an input/output unit and a processing unit. The input/output unit acquires sets of stroke data of a handwritten document. The processing unit is capable of implementing a first processing operation of deriving table data based on the sets of stroke data and supplying the table data to the input/output unit. The table data include first and second ruled line data, and first cell data. The first cell data include a shape pattern. A length in a second direction of a cell shape and an inter-ruled line distance along the second direction are independently modifiable. The first ruled line generated based on the first ruled line data extends in a first direction. The second ruled line generated based on the second ruled line data extends in the first direction. The second direction intersects the first direction.

### CROSS-REFERENCE TO RELATED APPLICATIONS

This application is based upon and claims the benefit of priority from Japanese Patent Application No. 2013-179845, filed on Aug. 30, 2013; the entire contents of which are incorporated herein by reference.

### FIELD

Embodiments described herein relate generally to a handwritten document processing device, a handwritten document processing method, and a handwritten document processing program.

### BACKGROUND

Information including a table is handwritten electronically using, for example, a pen input interface, etc. The handwritten table is appropriately processed to format the table. It is desirable to convert the handwritten table into easily-usable table data.

### BRIEF DESCRIPTION OF THE DRAWINGS

FIG. 1 is a schematic view showing a handwritten document processing device according to a first embodiment;

FIG. 2 is a schematic view showing stroke data of the handwritten document processing device according to the first embodiment;

FIG. 3 is a schematic view showing the processing result of the handwritten document processing device according to the first embodiment;

FIG. 4 is a schematic view showing processing results of the handwritten document processing device according to the first embodiment;

FIG. 5 is a schematic view showing an operation of the handwritten document processing device according to the first embodiment;

FIG. 6 is a flowchart showing an operation of the handwritten document processing device according to the first embodiment;

FIG. 7 is a flowchart showing an operation of the handwritten document processing device according to the first embodiment;

FIG. 8 is a flowchart showing an operation of the handwritten document processing device according to the first embodiment;

FIG. 9 is a schematic view showing an operation of the handwritten document processing device according to the first embodiment;

FIG. 10A and FIG. 10B are schematic views showing an operation of the handwritten document processing device according to the first embodiment;

FIG. 11 is a schematic view showing an operation of the handwritten document processing device according to the first embodiment;

FIG. 12 is a schematic view showing data used in the handwritten document processing device according to the first embodiment;

FIG. 13 is a schematic view showing the handwritten document processing device according to the first embodiment;

FIG. 14 is a schematic view showing the handwritten document processing device according to the first embodiment; and

FIG. 15 is a flowchart showing the operations of the handwritten document processing device according to the first embodiment.

### DETAILED DESCRIPTION

According to one embodiment, a handwritten document processing device includes an input/output unit and a processing unit. The input/output unit is configured to acquire a plurality of sets of stroke data of a handwritten document. The processing unit is capable of implementing a first processing operation of deriving table data based on the sets of stroke data acquired by the input/output unit and supplying the table data to the input/output unit. The table data include first ruled line data, second ruled line data, and first cell data. The first cell data include a shape pattern. The shape pattern is predetermined. A length in a second direction of a cell shape and an inter-ruled line distance along the second direction between a first ruled line and a second ruled line are independently modifiable. The first ruled line is generated based on the first ruled line data and extends in a first direction. The second ruled line is generated based on the second ruled line data and extends in the first direction. The second direction intersects the first direction. The cell shape is generated based on the first cell data and corresponds to the shape pattern.

Various embodiments will be described hereinafter with reference to the accompanying drawings.

The drawings are schematic or conceptual; and the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

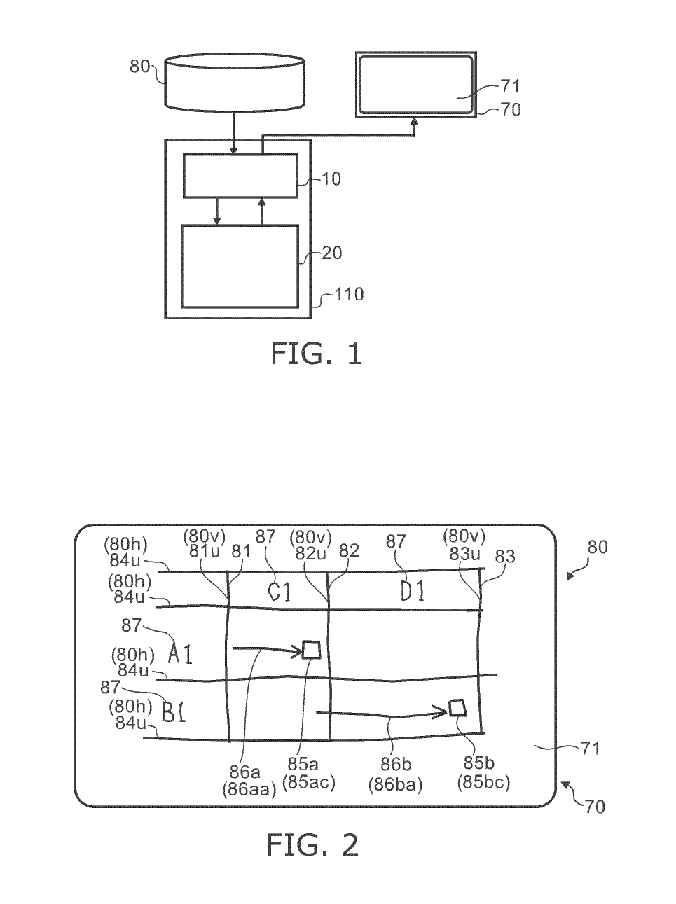

FIG. 1 is a schematic view showing a handwritten document processing device according to a first embodiment.

As shown in FIG. 1, the handwritten document processing device 110 according to the embodiment includes an input/output unit 10 and a processing unit 20.

The processing unit 20 includes, for example, a semiconductor device such as an arithmetic unit, etc. The processing unit 20 includes, for example, a computer. The input/output unit 10 includes, for example, a terminal of a semiconductor device, etc. The input/output unit 10 may include a terminal (including an interface) of a computer.

The input/output unit 10 acquires data. Any wired or wireless method is used in the acquisition of the data by the input/output unit 10. The data that is acquired includes, for example, multiple sets of stroke data 80 of the handwritten document. Examples of the stroke data 80 are described below.

The processing unit 20 performs processing based on the multiple sets of stroke data 80 acquired by the input/output unit 10. The processing unit 20 supplies the result (the data) of the processing to the input/output unit 10.

A display unit 70 is connectable to the handwritten document processing device 110. For example, the display unit 70 is connected to the input/output unit 10. The display unit 70 includes, for example, a liquid crystal display device, an organic EL display device, a projection-type display device, etc. The display unit 70 may include a printer. In the embodiment, “displaying” also includes printing. In the embodiment, the display unit 70 is arbitrary. The display unit 70 includes a display region 71. In the case where a printer is used as the display unit 70, the display region 71 corresponds to a printable region.

The stroke data 80 is displayable by the display unit 70. The result (the data) of the processing of the processing unit 20 is displayable by the display unit 70. Hereinbelow, an example of a state is described in which the stroke data 80 and the result (the data) of the processing are displayed by the display unit 70.

FIG. 2 is a schematic view showing stroke data of the handwritten document processing device according to the first embodiment.

As shown in FIG. 2, the multiple sets of stroke data 80 include, for example, information having a table form. A user inputs the table by, for example, handwriting on a tablet for input. For example, a pen, a finger, or the like is used for the input.

The multiple sets of stroke data 80 include a first portion 81u, a second portion 82u, and a third portion 83u. For example, the first portion 81u includes first stroke data 81. For example, the second portion 82u includes second stroke data 82. For example, the third portion 83u includes third stroke data 83.

In the example, the first portion 81u, the second portion 82u, and the third portion 83u correspond to vertical ruled line input data 80v. The first portion 81u, the second portion 82u, and the third portion 83u have line configurations. In other words, the first stroke data 81, the second stroke data 82, and the third stroke data 83 have line configurations.

In the example, the multiple sets of stroke data 80 further include a fourth portion 84u. In the example, multiple fourth portions 84u are provided. The fourth portions 84u correspond to horizontal ruled line input data 80h. The multiple fourth portions 84u have line configurations.

In the example, the multiple sets of stroke data 80 include cell portions (a first cell portion 85a and a second cell portion 85b), etc. The first cell portion 85a includes cell stroke data 85ac. The second cell portion 85b includes cell stroke data 85bc. The cell stroke data 85ac and the cell stroke data 85bc are portions of the multiple sets of stroke data 80.

In the example, the cell portions (the first cell portion 85a and the second cell portion 85b) include quadrilateral shape patterns. The shape patterns are handwritten. Examples of other patterns of the cell portions are described below.

In the example, the multiple sets of stroke data include arrow portions (a first arrow portion 86a, a second arrow portion 86b, etc.). The first arrow portion 86a includes first arrow stroke data 86aa. The second arrow portion 86b includes second arrow stroke data 86ba. The first arrow stroke data 86aa and the second arrow stroke data 86ba are portions of the multiple sets of stroke data 80.

In the example, the multiple sets of stroke data 80 further include character portions 87. The character portions 87 include a portion of the multiple sets of stroke data 80. In the example, the character portions 87 include the handwritten character information of “A1,” “B1,” “C1,” and “D1.”

The multiple sets of stroke data 80 of such a handwritten document are supplied to the input/output unit 10.

The multiple sets of stroke data 80 include, for example, multiple sets of time series data. For example, the multiple sets of time series data correspond respectively to multiple strokes of handwriting. Each stroke includes multiple coordinates.

One set of stroke data includes, for example, the data of (x(1, 1), y(1, 1)), (x(1, 2), y(1, 2)), . . . , and (x(1, N(1)), y(1, N(1))). Another set of stroke data includes the data of (x(2, 1), y(2, 1)), (x(2, 2), y(2, 2)), . . . , and (x(2, N(2)), y(2, N(2))). Here, N(i) is the number of points of the sampling for the ith stroke. The stroke data corresponds to handwritten data of the handwritten input. Examples of the data structure of the stroke data are described below.

The processing unit 20 implements a processing operation based on the multiple sets of stroke data 80 acquired by the input/output unit 10. A first processing operation is described as an example.

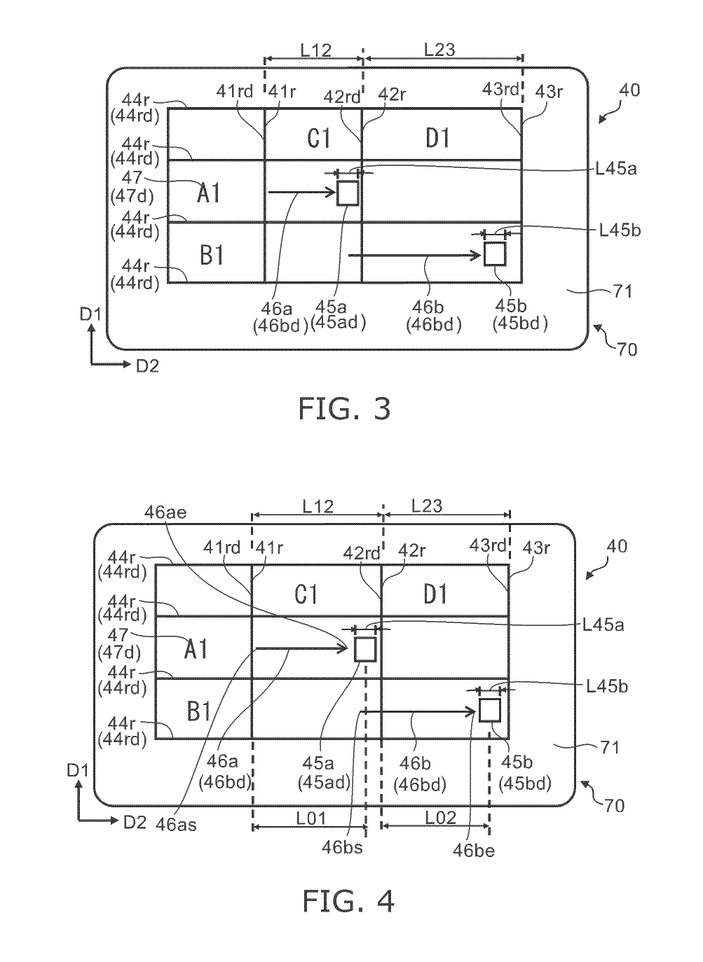

FIG. 3 is a schematic view showing the processing result of the handwritten document processing device according to the first embodiment.

FIG. 3 shows table data 40 derived by the processing of the processing unit 20. The table data 40 is displayable by the display unit 70. An example of the state in which the table data 40 is displayed by the display unit 70 will now be described.

The table data 40 includes first ruled line data 41rd, second ruled line data 42rd, and first cell data 45ad. The first cell data 45ad includes a predetermined shape pattern. For example, the shape pattern includes at least one selected from a circle, a flattened circle, and a polygon. In the example, the shape pattern is a quadrilateral. In the example, the table data 40 further includes second cell data 45bd. The second cell data 45bd includes a predetermined shape pattern. In the example, the table data 40 further includes third ruled line data 43rd.

The table data 40 further includes arrow data (first arrow data 46ad, second arrow data 46bd, etc.).

The table data 40 includes fourth ruled line data 44rd. The fourth ruled line data 44rd corresponds to the fourth portions 84u (the horizontal ruled line input data 80h) of the stroke data 80. The table data 40 further includes character data 47d. The character data 47d corresponds to the character portions 87 of the multiple sets of stroke data 80.

When such data is displayed by, for example, the display unit 70, various shapes that are generated based on the data are displayed by the display unit 70.

As shown in FIG. 3, a first ruled line 41r is generated based on the first ruled line data 41rd. A second ruled line 42r is generated based on the second ruled line data 42rd. A third ruled line 43r is generated based on the third ruled line data 43rd.

A cell shape (a first cell shape 45a) that corresponds to the shape pattern recited above is generated based on the first cell data 45ad. A cell shape (a second cell shape 45b) that corresponds to the shape pattern recited above is generated based on the second cell data 45bd.

A first arrow 46a is generated based on the first arrow data 46ad. A second arrow 46b is generated based on the second arrow data 46bd. Fourth ruled lines 44r are generated based on the fourth ruled line data 44rd. Characters 47 are displayed based on the character data 47d.

The first ruled line 41r extends in a first direction D1. The first direction D1 is, for example, one direction inside the display region 71 of the display unit 70. In the example, the first direction D1 is the vertical direction of the display region 71. In the embodiment, the first direction D1 may be the left and right direction of the display region 71. The first direction D1 is arbitrary.

The second ruled line 42r extends in the first direction D1. The third ruled line 43r also extends in the first direction D1. The second ruled line 42r is separated from the first ruled line 41r in a second direction D2. The second direction D2 is a direction that intersects the first direction D1. For example, the second direction D2 is perpendicular to the first direction D1. The third ruled line 43r is separated from the first ruled line 41r in the second direction D2 and separated from the second ruled line 42r in the second direction D2.

In the example, the second ruled line 42r is disposed between the first ruled line 41r and the third ruled line 43r. For example, at least a portion of the second ruled line 42r is disposed between at least a portion of the first ruled line 41r and at least a portion of the third ruled line 43r. The first ruled line 41r, the second ruled line 42r, and the third ruled line 43r correspond to, for example, ruled lines in the vertical direction of the table. The first ruled line 41r and the second ruled line 42r are, for example, adjacent to each other in the second direction D2. The second ruled line 42r and the third ruled line 43r are, for example, adjacent to each other in the second direction D2.

The processing unit 20 according to the embodiment can output the ruled line data and the cell data by separating the ruled line data and the cell data from each other. Therefore, for example, the ruled lines generated based on the ruled line data are modifiable independently from the cell shapes generated based on the cell data.

For example, a first inter-ruled line distance L12 is the distance along the second direction D2 between the first ruled line 41r and the second ruled line 42r. On the other hand, a length L45a is the length in the second direction D2 of a cell shape (e.g., the first cell shape 45a). A length L45b is the length in the second direction D2 of a cell shape (e.g., the second cell shape 45b). The first inter-ruled line distance L12 is modifiable when displayed by the display unit 70.

For example, there are cases where the user desires to modify the widths of the cells of the table. In such a case, the first inter-ruled line distance L12 is modified by the user. In such a case, in the embodiment, the length L45a and the length L45b of the cell shapes, etc., are independent of the modifications of the first inter-ruled line distance L12. For example, the width of the first cell shape 45a (in the example, the quadrilateral) can be unchanged even when the user modifies the widths of the cells of the table.

According to the embodiment, a handwritten document processing device that converts a handwritten table into easily-usable table data can be provided.

For example, there is a reference example in which a handwritten document is read as image data. For example, in such a reference example, it is difficult to discriminate and recognize the shapes (the polygons, the arrows, etc.) and the ruled lines. For example, the data relating to shapes is not discriminated from the data relating to ruled lines. Therefore, there are cases where the shapes that are disposed in the cells change in conjunction with the widths of the cells (the spacing between the ruled lines) when the widths are modified. Therefore, the reference example is difficult to use. Conversely, in the embodiment, the widths of the shapes inside the cells can be unchanged when the widths of the cells are modified.

An example of a modification of the table will now be described.

FIG. 4 is a schematic view showing processing results of the handwritten document processing device according to the first embodiment.

As shown in FIG. 4, the widths of the cells (the spacing between the ruled lines) of the table are modifiable from the state shown in FIG. 3. In the example, the distance (the first inter-ruled line distance L12) along the second direction D2 between the first ruled line 41r and the second ruled line 42r is modified. In other words, the first inter-ruled line distance L12 of FIG. 4 is longer than the first inter-ruled line distance L12 of FIG. 3. In the example, the distance (a second inter-ruled line distance L23) along the second direction D2 between the second ruled line 42r and the third ruled line 43r also is modified. In other words, the second inter-ruled line distance L23 of FIG. 4 is shorter than the second inter-ruled line distance L23 of FIG. 3. Thus, in FIG. 4, the widths of the cells are enlarged or reduced.

In such a case, as shown in FIG. 4, the widths (the length L45a and the length L45b) of the cell shapes (the first cell shape 45a and the second cell shape 45b) are the same as those of FIG. 3.

In other words, in the embodiment, the lengths (the length L45a and the length L45b) in the second direction D2 of the cell shapes (the first cell shape 45a and the second cell shape 45b) generated based on the cell data to correspond to the shape pattern and the first inter-ruled line distance L12 along the second direction D2 between the first ruled line 41r generated based on the first ruled line data 41rd to extend in the first direction D1 and the second ruled line 42r generated based on the second ruled line data 42rd to extend in the first direction D1 are independently modifiable.

According to the embodiment, a handwritten document processing device that converts a handwritten table into easily-usable table data can be provided.

In the example, the first inter-ruled line distance L12 is modified without modifying the widths (the length L45a and the length L45b) of the cell shapes. In the embodiment, the widths (the length L45a and the length L45b) of the cell shapes may be modified. In such a case, the degree (e.g., the magnification) of the modification of the first inter-ruled line distance L12 is independent of the degree (e.g., the magnification) of the modification of the width (the length L45a) of the cell shape. The degree (e.g., the magnification) of the modification of the second inter-ruled line distance L23 is independent of the degree (e.g., the magnification) of the modification of the width (the length L45b) of the cell shape.

For example, as shown in FIG. 4, the position of the cell shape inside the cell is a relative position inside the cell. For example, as shown in FIG. 4, when the width of the cell including the characters “C1” is enlarged from that of FIG. 3, the position of the cell shape (the first cell shape 45a) is modified according to the enlargement. For example, when the width of the cell including the characters “D1” is reduced from that of FIG. 3, the position of the cell shape (the second cell shape 45b) is modified according to the reduction.

For example, the cell shape (the first cell shape 45a) is disposed between the first ruled line 41r and the second ruled line 42r. At this time, the distance (a first distance L01) along the second direction D2 between the first ruled line 41r and the position along the second direction D2 of the cell shape (the first cell shape 45a) is linked to the first inter-ruled line distance L12. For example, the first distance L01 is proportional to the first inter-ruled line distance L12. The first distance L01 increases in conjunction with the increase of the first inter-ruled line distance L12.

The position along the second direction D2 of the cell shape (the first cell shape 45a) may be, for example, the center of the cell shape (the first cell shape 45a) along the second direction D2. The position along the second direction D2 of the cell shape (the first cell shape 45a) may be, for example, the center along the second direction D2 of multiple points of the circumscribing rectangle of the cell shape (the first cell shape 45a).

On the other hand, in the example, the second cell shape 45b is disposed between the second ruled line 42r and the third ruled line 43r. In such a case, the distance (a second distance L02) along the second direction D2 between the second ruled line 42r and the position along the second direction D2 of the second cell shape 45b is linked to the second inter-ruled line distance L23. For example, the second distance L02 is proportional to the second inter-ruled line distance L23. The second distance L02 decreases in conjunction with the decrease of the second inter-ruled line distance L23.

On the other hand, in the example, the shapes of arrows (the first arrow 46a, the second arrow 46b, etc.) are provided in the table. The lengths of the arrows change in conjunction with the enlargement of the widths of the cells.

For example, the first arrow 46a has a start point portion 46as and an end point portion 46ae. The start point portion 46as is positioned between the first ruled line 41r and the second ruled line 42r. The start point portion 46as is separated from the first ruled line 41r and separated from the second ruled line 42r. The end point portion 46ae is positioned between the start point portion 46as and the second ruled line 42r. The end point portion 46ae is separated from the first ruled line 41r and separated from the second ruled line 42r. The length along the second direction D2 of the first arrow 46a is shorter than the length along the second direction D2 between the first ruled line 41r and the second ruled line 42r.

The position of the start point portion 46as and the position of the end point portion 46ae can be changed in conjunction with the widths of the cells (the spacing between the ruled lines).

For example, the distance along the second direction D2 between the first ruled line 41r and the start point portion 46as is linked (e.g., proportional) to the distance (the first inter-ruled line distance L12) along the second direction D2 between the first ruled line 41r and the second ruled line 42r.

For example, the distance along the second direction D2 between the second ruled line 42r and the end point portion 46ae is linked (e.g., proportional) to the distance (the first inter-ruled line distance L12) along the second direction D2 between the first ruled line 41r and the second ruled line 42r.

For example, the length along the first direction D1 of the end point portion 46ae is longer than the length along the first direction D1 of the start point portion 46as. Thereby, for the first arrow 46a, the discrimination between the start point portion 46as and the end point portion 46ae is easy.

The first arrow 46a is generated based on the first arrow data 46ad. For example, the start point of the strokes included in the first arrow data 46ad corresponds to the start point portion 46as. For example, the end point of the strokes included in the first arrow data 46ad corresponds to the end point portion 46ae.

In the example, the first arrow 46a is provided between the first ruled line 41r and the second ruled line 42r and does not intersect the ruled lines in the horizontal direction. On the other hand, the second arrow 46b intersects a ruled line (in the example, the second ruled line 42r) in the horizontal direction.

In other words, the table data 40 includes the third ruled line data 43rd and the second arrow data 46bd. The third ruled line 43r that is generated based on the third ruled line data 43rd extends in the first direction D1. The second ruled line 42r is disposed between the first ruled line 41r and the third ruled line 43r. The second arrow 46b that is generated based on the second arrow data 46bd extends in the second direction D2.

A start point portion 46bs of the second arrow 46b is positioned between the first ruled line 41r and the second ruled line 42r. An end point portion 46be of the second arrow 46b is positioned between the second ruled line 42r and the third ruled line 43r. In other words, the second arrow 46b intersects the second ruled line 42r.

In such a case, the position of the start point portion 46bs of the second arrow 46b and the position of the end point portion 46be of the second arrow 46b are modifiable according to the modification of the widths of the cells.

For example, the distance along the second direction D2 between the second ruled line 42r and the start point portion 46bs of the second arrow 46b is linked (e.g., proportional) to the distance (the first inter-ruled line distance L12) along the second direction D2 between the first ruled line 41r and the second ruled line 42r.

For example, the distance along the second direction D2 between the second ruled line 42r and the end point portion 46be of the second arrow 46b is linked (e.g., proportional) to the distance (the second inter-ruled line distance L23) along the second direction D2 between the second ruled line 42r and the third ruled line 43r.

In other words, a table having suppressed incongruity can be displayed by changing the position of the start point portion 46as and the position of the end point portion 46ae in conjunction with the widths of the cells (the spacing between the ruled lines).

According to the embodiment, a handwritten document processing device that converts a handwritten table into easily-usable table data can be provided.

Thus, the processing unit 20 can perform the second processing operation. The second processing operation derives the table data 40 based on the multiple sets of stroke data 80 acquired by the input/output unit 10 and supplies the table data 40 to the input/output unit 10, where the table data 40 includes the first ruled line data 41rd, the second ruled line data 42rd, and the first arrow data 46ad.

As recited above, the first ruled line 41r that is generated based on the first ruled line data 41rd extends in the first direction D1. The second ruled line 42r that is generated based on the second ruled line data 42rd extends in the first direction D1. The first arrow 46a that is generated based on the first arrow data 46ad extends in the second direction D2 intersecting the first direction D1. The start point portion 46as of the first arrow 46a is positioned between the first ruled line 41r and the second ruled line 42r. The end point portion 46ae of the first arrow 46a is positioned between the start point portion 46as and the second ruled line 42r.

From the data recited above obtained in the second processing operation, the distance along the second direction D2 between the first ruled line 41r and the start point portion 46as is linked (e.g., proportional) to the first inter-ruled line distance L12. The distance along the second direction D2 between the second ruled line 42r and the end point portion 46ae is linked (e.g., proportional) to the first inter-ruled line distance L12.

The first processing operation and the second processing operation recited above may be implemented simultaneously.

Such a first processing operation and second processing operation are possible by the processing of the multiple stroke data 80 by the processing unit 20 being processed by, for example, the data corresponding to cell shapes or arrows and the data corresponding to ruled lines being processed separately. An example of the processing of the multiple stroke data 80 implemented by the processing unit 20 will now be described.

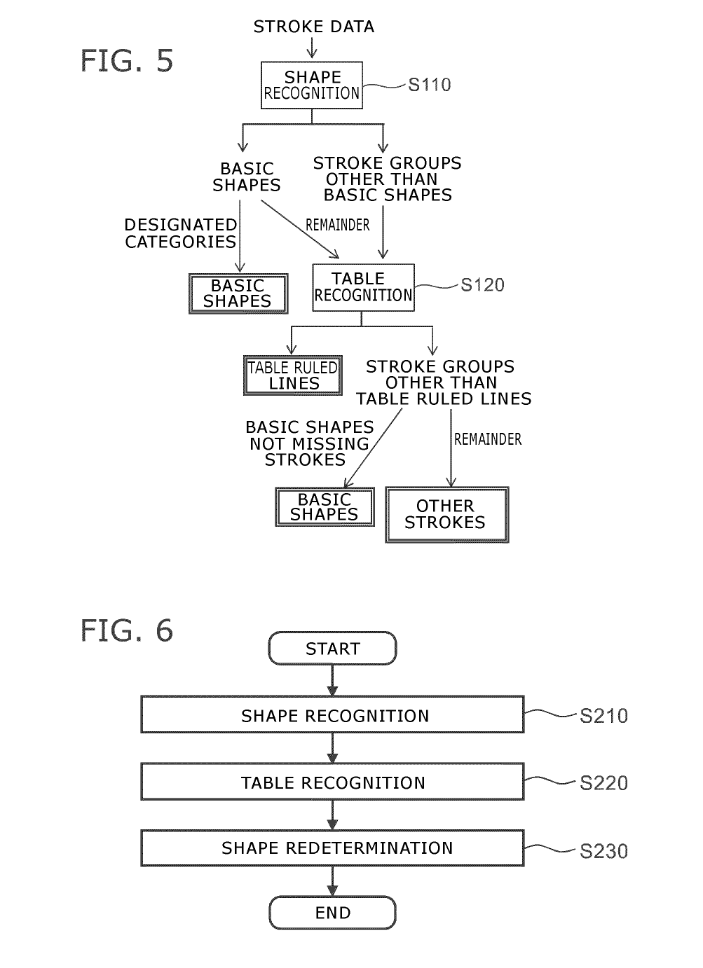

FIG. 5 is a schematic view showing an operation of the handwritten document processing device according to the first embodiment.

As shown in FIG. 5, for example, shape recognition is performed for the stroke groups (the multiple stroke data 80) to be recognized (step S110). For example, the basic shapes (the circles, the flattened circles, the quadrilaterals, the arrows, etc.) are recognized by the shape recognition.

In the shape recognition, the strokes that are recognized as a basic shape of a designated category are established to be the basic shape of the designated category.

Table recognition is performed for the stroke groups of the multiple stroke data 80 other than the basic shapes of the designated categories (step S120). The table ruled lines and the table structures (the number of rows, the number of columns, the cell regions, etc.) of the table data 40 are recognized by the table recognition.

At this time, there is a possibility that, for example, an error may occur in the recognition of the table ruled lines. To handle this, for example, the table recognition is performed without the stroke groups recognized as arrows in the shape recognition.

For example, the stroke groups recognized as table ruled lines are established to be table ruled lines. At this time, even when a stroke group is recognized as table ruled lines and recognized as a basic shape, the stroke group may be established to be table ruled lines. Thereby, for example, table ruled lines that are recognized as quadrilaterals in the shape recognition are corrected to be table ruled lines.

For example, in the case where the stroke group is recognized as a basic shape and the entire stroke group is not table ruled lines, the stroke group is established to be a basic shape of the category. In other words, in the case where a portion of the stroke group is recognized as a table ruled line, the remainder of the stroke group is not set to be a basic shape.

The stroke groups that are not established in the processing recited above are established to be “other strokes.” For example, linearization processing may be implemented for the “other strokes.” The “other strokes” may be recognized as, for example, characters. After such processing is implemented, the shape recognition may be performed again for the “other strokes.”

Thereby, the multiple stroke data 80 are classified into, for example, “basic shapes,” “table ruled lines,” and “other strokes.”

As a result of the classification, for example, the first ruled line data 41rd, the second ruled line data 42rd, the third ruled line data 43rd, the first cell data 45ad, the second cell data 45bd, the first arrow data 46ad, the second arrow data 46bd, etc., of the table data 40 are derived.

Thus, the first processing operation recited above includes the shape recognition processing (e.g., step S110) of dividing the multiple sets of stroke data 80 into the first cell data 45ad and the non-cell data that is different from the first cell data 45ad. The first processing operation further includes the ruled line derivation processing (e.g., step S120) of deriving the first ruled line data 41rd and the second ruled line data 42rd from the non-cell data.

On the other hand, the second processing operation includes the arrow recognition processing (step S110) of dividing the multiple sets of stroke data 80 into the first arrow data 46ad and the non-arrow data that is different from the first arrow data 46ad. The second processing operation further includes the ruled line derivation processing (e.g., step S120) of deriving the first ruled line data 41rd and the second ruled line data 42rd from the non-arrow data.

Such processing can convert a handwritten table into easily-usable table data.

FIG. 6 is a flowchart showing an operation of the handwritten document processing device according to the first embodiment.

FIG. 6 shows the operation of the processing unit 20.

In the shape recognition (step S210) as shown in FIG. 6, the shapes of the categories belonging to a first shape category group are recognized from the stroke data 80. Then, for example, a shape attribute that indicates being a shape of the first shape category is added to the stroke data included in the shapes. The correspondence between each of the shapes and the stroke data included in each of the shapes is output.

The table recognition (step S220) is performed for, for example, designated stroke data. The designated stroke data is, for example, the stroke data 80 other than the stroke data to which the shape attribute of a category belonging to a second shape category group is added. The second shape category group is a partial set of the first shape category group. The second shape category group is, for example, “arrow.” The table ruled lines and the cell regions of the table are recognized for the designated stroke data. The correspondence between the table ruled lines and the stroke data included in the table ruled lines is output.

In the shape redetermination (step S320) for each of the shapes, a shape is rejected if, for example, the attribute of table ruled lines is added to some of the stroke data included in the shape. Then, for example, the shape attribute added to the other stroke data included in the shape is removed.

By such processing, the shapes (the cell data, the arrows, etc.) and the ruled lines are separated and recognized. The stroke data to which the table ruled line attribute is added, the stroke data to which the shape attributes are added, and the other stroke data are outputtable.

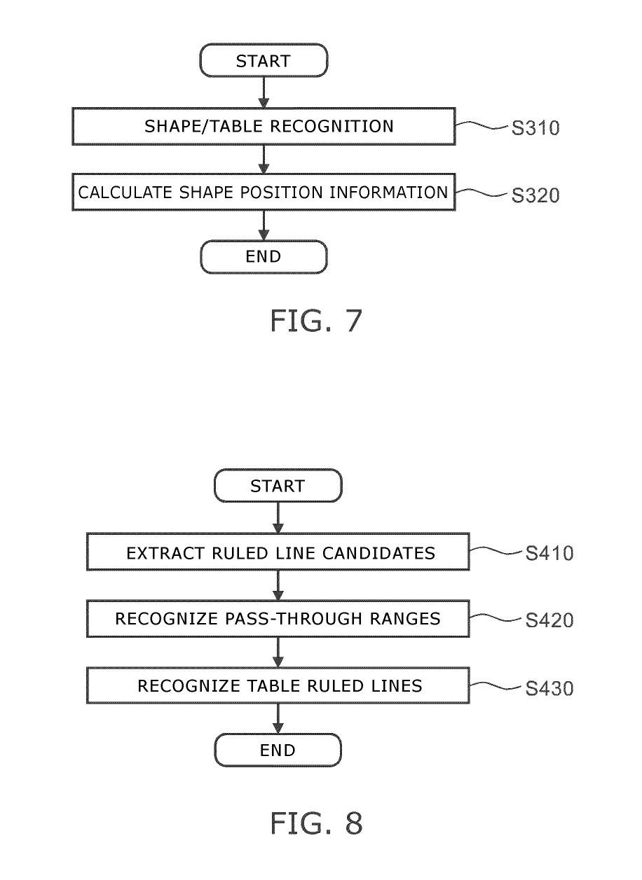

FIG. 7 is a flowchart showing an operation of the handwritten document processing device according to the first embodiment.

FIG. 7 shows the operation of the processing unit 20. The processing unit 20 implements an operation of, for example, describing the shape data as relative positions inside the table.

In the shape/table recognition (step S310), for example, the table and the shapes of the categories belonging to the first shape category group are recognized from the stroke data 80. The information of the shape category of each shape, the correspondence between each shape and the stroke data included in each shape, and the cell regions of the table are output.

In the calculation of the shape position information (step S320), for example, in the case where the shape category is a circle or a polygon, the positions of the corners of the circumscribing rectangle of the strokes included in the shape are calculated as the relative position in the cell region. The positions of the corners are used as the shape position information. The shape position information is outputtable.

FIG. 8 is a flowchart showing an operation of the handwritten document processing device according to the first embodiment.

FIG. 8 shows the operation of suppressing the detection of the table ruled lines.

In the extraction of the ruled line candidates (step S410), multiple ruled line candidates are extracted from the stroke data 80. For example, the ruled line candidates are extracted based on the size and distribution (e.g., the entropy), etc., of the projection component of the stroke data when projected onto any axis (e.g., two orthogonal axes, etc.).

In the recognition of the pass-through ranges (step S420), for example, the table is made using the ruled line candidates; and the ranges through which the ruled line candidates pass are recognized.

In the recognition of the table ruled lines (step S430), for example, the table ruled lines and the cell regions of the table are recognized based on the pass-through ranges of the ruled line candidates.

Based on the processing recited above, the information of the cell regions and the correspondence between the table ruled lines and the stroke data included in the table ruled lines are outputtable.

According to the processing unit 20 according to the embodiment, for example, based on the pass-through range of each of the ruled line candidates that are extracted, the ruled line candidates that are inappropriate as the table are not processed as table ruled lines.

For example, in a reference example, there is a method for determining lines having lengths not less than a threshold to be ruled lines. In such a case, portions (e.g., arrows, etc.) other than the table also may be recognized as table ruled lines.

Conversely, according to the embodiment, the ruled lines and the arrows are recognized separately. Thereby, the handwritten document can be processed more appropriately.

For example, the table ruled line candidates are extracted; and the table is made. Then, the ranges through which the ruled line candidates pass are recognized. At this time, for example, in the case where there are no vertical ruled lines passing from the cell of the upper end of the table to the cell of the lower end of the table and there are no horizontal ruled lines passing from the cell of the left end of the table to the cell of the right end of the table, the ruled line candidates that are extracted are not set to be table ruled lines. For example, in the case where one of the ruled line candidates has a pass-through range of one cell and the length of the ruled line candidate is not more than a prescribed proportion of the cell, the ruled line candidate is not set to be a table ruled line.

By such processing, the overdetection of table ruled lines in the table recognition can be suppressed.

In the embodiment, a straight-line approximation of the “other strokes” may be implemented. Further, shape recognition of the “other strokes” may be implemented.

Based on the table data, at least one selected from a portion of the rows and a portion of the columns can be enlarged when generating the table. At this time, the relative positions inside the cells of the shapes inside the table are maintained. In the embodiment, it is possible to make the sizes of the multiple cells of the table uniform. The colors may be different between the table ruled lines and the shapes (at least one selected from the cell shapes and the arrow).

In the table ruled line recognition, the ruled line candidates that do not pass through cells are not set to be table ruled lines. In the table ruled line recognition, a horizontal-direction ruled line candidate that passes through only one cell and has a length that is not more than a prescribed proportion of the horizontal width of the cell is not set to be a table ruled line. In the table ruled line recognition, a vertical-direction ruled line candidate that passes through only one cell and has a length that is not more than a prescribed proportion of the vertical width of the cell is not set to be a table ruled line.

In the case where the number of rows is not more than a predetermined number when the table is made, the ruled line candidates may be rejected. In the case where the number of columns is not more than a predetermined number when the table is made, the ruled line candidates may be rejected.

For example, a ruled line candidate that has an end point separated from the edge of the cell and positioned at the cell center vicinity, the ruled line candidate may be determined not to be a table ruled line. Based on the pass-through ranges of the ruled line candidates, cell regions may be recognized as merged cells for portions that are not passed through.

FIG. 9 is a schematic view showing an operation of the handwritten document processing device according to the first embodiment.

FIG. 9 shows the multiple stroke data 80. In the example, the stroke data 80 is ruled line candidates.

As shown in FIG. 9, for example, the stroke data 80 of the multiple stroke data 80 that has a length not less than a prescribed threshold is set to be a ruled line candidate 88. The stroke data 80 of the multiple stroke data 80 that has an aspect ratio not less than a prescribed threshold is set to be the ruled line candidate 88. The aspect ratio is, for example, the ratio of the vertical length to the horizontal length of the circumscribing rectangle of the stroke data 80. The aspect ratio may be, for example, the ratio of the horizontal length to the vertical length of the circumscribing rectangle of the stroke data 80.

For example, there are cases where the end point of one of the stroke data is disposed proximally to the start point of one other of the stroke data, and the extension directions of the stroke data are the same. In such a case, the stroke data may be integrated as one ruled line candidate 88.

There are cases where one of the stroke data extends continuously from one direction into another direction. In such a case, the portion extending in the one direction may be set to be one ruled line candidate 88; and the portion extending in the one other direction may be set to be one other ruled line candidate 88.

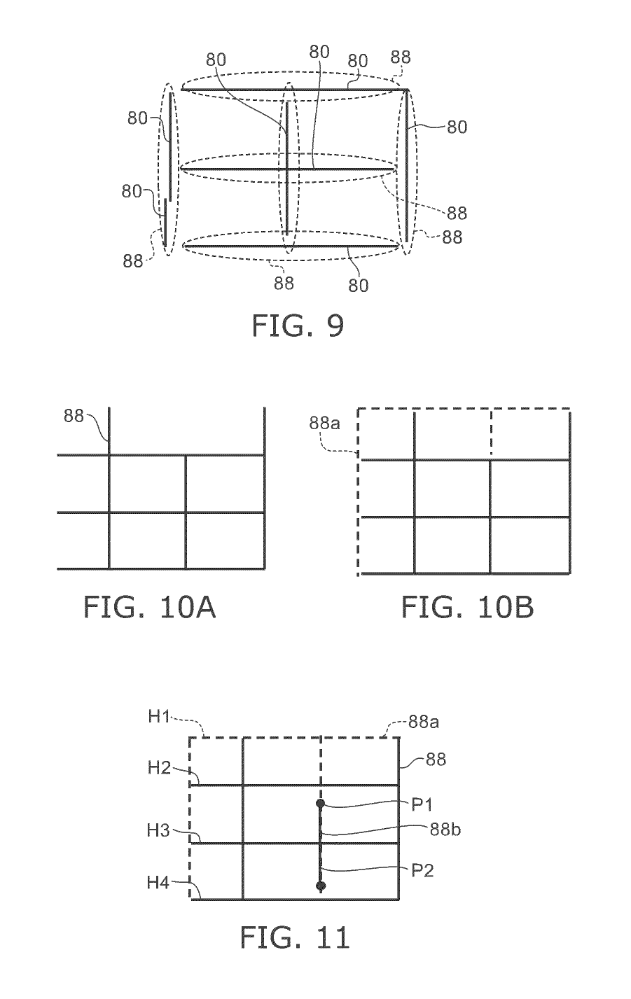

FIG. 10A and FIG. 10B are schematic views showing an operation of the handwritten document processing device according to the first embodiment.

As shown in FIG. 10A, the ruled line candidates 88 are extracted in the derivation of the table data 40. In such a case, as in the example, a portion of the ruled lines may be omitted.

In such a case, as shown in FIG. 10B, ruled lines 88a may be added. For example, the pass-through ranges of the ruled line candidates 88 can be recognized; and the ruled lines 88a can be added based on the result.

FIG. 11 is a schematic view showing an operation of the handwritten document processing device according to the first embodiment. As shown in FIG. 11, the ruled line candidates 88 include horizontal ruled lines H1 to H4. In such a case, the ends of a ruled line candidate 88b are connected to none of the horizontal ruled lines H1 to H4. In the example, one end P1 of the ruled line candidate 88b is proximal to the horizontal ruled line H2 but does not contact the horizontal ruled line H2. The other end P2 of the ruled line candidate 88b is proximal to the horizontal ruled line H4 but does not contact the horizontal ruled line H4.

For example, in the case where the distance between the end P1 and the horizontal ruled line H2 is not more than a prescribed threshold, the ruled line candidate 88b may be modified to cause the position of the end P1 to contact the horizontal ruled line H2. In the case where the distance between the end P2 and the horizontal ruled line H4 is not more than the prescribed threshold, the ruled line candidate 88b may be modified to cause the position of the end P2 to contact the horizontal ruled line H4.

The threshold is, for example, predetermined. For example, the threshold may be determined to be proportional to the average cell size. The threshold may be determined based on, for example, the size of the circumscribing rectangle of the ruled line candidate 88b. The threshold may be determined based on the size of the cells in which the ends of the ruled line candidate 88b are positioned.

For example, when the distance between the end P1 and the horizontal ruled line H2 is less than the threshold, the ruled line candidate 88b is determined not to be a ruled line. For example, when the distance between the end P2 and the horizontal ruled line H4 is less than the threshold, the ruled line candidate 88b is determined not to be a ruled line.

By such processing, the precision of the discrimination between the shapes and the ruled lines of the table increases.

In the example of the processing shown in FIG. 5, table recognition processing is implemented for the strokes corresponding to the basic shapes of the designated categories. The embodiment is not limited thereto. For example, for all of the multiple strokes, first, the table recognition processing may be implemented; and then, other processing to set the strokes corresponding to the basic shapes of the designated categories not to be the ruled line candidates may be performed in the ruled line extraction of the table recognition processing. For example, there are cases where a handwritten ruled line exists that cannot be an outer edge of the frame; and at least a portion of the strokes corresponding to an “arrow” exists in a region outside the ruled line. In such a case, because the strokes that correspond to the arrow exist, the region where the arrow exists can be recognized as a “cell” of the table by performing the other processing recited above.

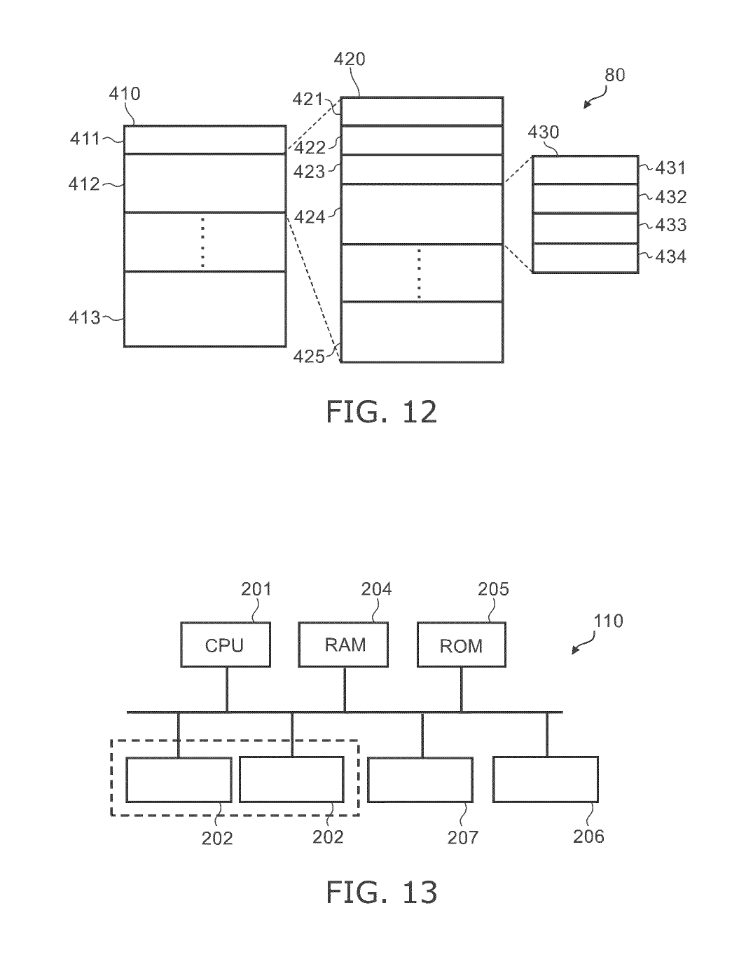

FIG. 12 is a schematic view showing data used in the handwritten document processing device according to the first embodiment.

FIG. 12 shows an example of the data structure of the multiple sets of stroke data 80. The stroke data 80 is, for example, handwritten data.

For example, an ink data structure 410 includes a total stroke count 411 and multiple stroke structures (a stroke structure 412, a stroke structure 413, etc.).

“Stroke” corresponds to a stroke that is input by handwriting. The stroke corresponds to, for example, the path of a pen or the like from where the pen or the like contacts the input plane to where the pen or the like leaves the input plane. For example, points on the path are sampled at a prescribed timing (e.g., a constant period). The stroke is expressed by, for example, the time series of the points that are sampled.

A stroke structure 420 of one stroke is, for example, one selected from the stroke structure 412, the stroke structure 413, etc. The stroke structure 420 is expressed by, for example, the set (the point structures) of the values of the coordinates on the plane where the pen has moved.

For example, the stroke structure 420 includes a total point count 421, a start time 422, a circumscribing shape 423, and point structures (a point structure 424, a point structure 425, etc.). The total point count 421 is the number of points that form the stroke. The number of point structures is the total point count 421.

The start time 422 is, for example, the time at which the stroke is drawn by the pen contacting the input plane. The circumscribing shape 423 is the circumscribing shape of the path of the stroke on the document plane. It is favorable for the circumscribing shape 423 to be, for example, a rectangle of the minimum surface area that contains the stroke on the document plane.

The point structures (the point structure 424, the point structure 425, etc.) depend on, for example, the input device. A point structure 430 which is one point structure includes, for example, an x-coordinate 431, a y-coordinate 432, writing pressure 433, and a time difference 434. The x-coordinate 431 is the coordinate in the x-direction of the sampled point. The y-coordinate 432 is the coordinate in the y-direction of the sampled point. The writing pressure 433 is the writing pressure of the sampled point. The time difference 434 is, for example, the time difference between the initial time (e.g., the start time 422 recited above) and the time of the sampling of the point. The point structure 430 includes four such values.

For example, the coordinates are a coordinate system in the document plane. For example, the upper left corner of the document plane is used as the origin of the coordinates. For example, the values of the coordinates increase from the origin toward the lower right corner. The coordinates may be expressed by such positive values.

For example, there are cases where the input device does not acquire the writing pressure, or the data of the writing pressure is not used in subsequent processing even when acquired. In such a case, the writing pressure 433 is omissible. Or, data that indicates that the writing pressure 433 is invalid may be added to the writing pressure 433.

In the stroke structure 420, the actual data of the x-coordinate 431, the y-coordinate 432, etc., may be written to the region of each of the point structures 430. Or, in the stroke structure 420, link information to the corresponding point structure 430 may be written to the region of each of the point structures 430. For example, this is applicable in the case where the data of the stroke structure 420 and the data of the point structure 430 are managed separately.

The handwritten document processing device 110 according to the embodiment is, for example, a stand-alone device. For example, the configuration of the handwritten document processing device 110 may be dispersed over multiple nodes. The multiple nodes can communicate with each other via, for example, a network.

The handwritten document processing device 110 includes, for example, a desktop computer, a laptop computer, a portable computer, etc. The handwritten document processing device 110 includes a portable information device, an information device including a touch panel, a smartphone, etc. The document processing device 110 includes various information processing devices. The handwritten document processing device 110 includes various devices.

FIG. 13 is a schematic view showing the handwritten document processing device according to the first embodiment.

FIG. 13 is a block diagram of the handwritten document processing device 110. FIG. 13 shows an example of hardware of the handwritten document processing device 110.

The handwritten document processing device 110 includes, for example, a CPU 201, an input device 202, an output device 203, a RAM 204, a ROM 205, an external memory interface 206, and a communication interface 207. For example, at least one selected from the input device 202, the output device 203, the external memory interface 206, and the communication interface 207 is used as the input/output unit 10. For example, the CPU 201 is used as the processing unit 20.

In the case where a touch panel is used as the handwritten document processing device 110, for example, a liquid crystal panel, a pen, a stroke sensor provided on the liquid crystal panel, etc., are utilized.

For example, a portion of the handwritten document processing device 110 may be provided in a client; and another portion of the handwritten document processing device 110 may be provided in a server.

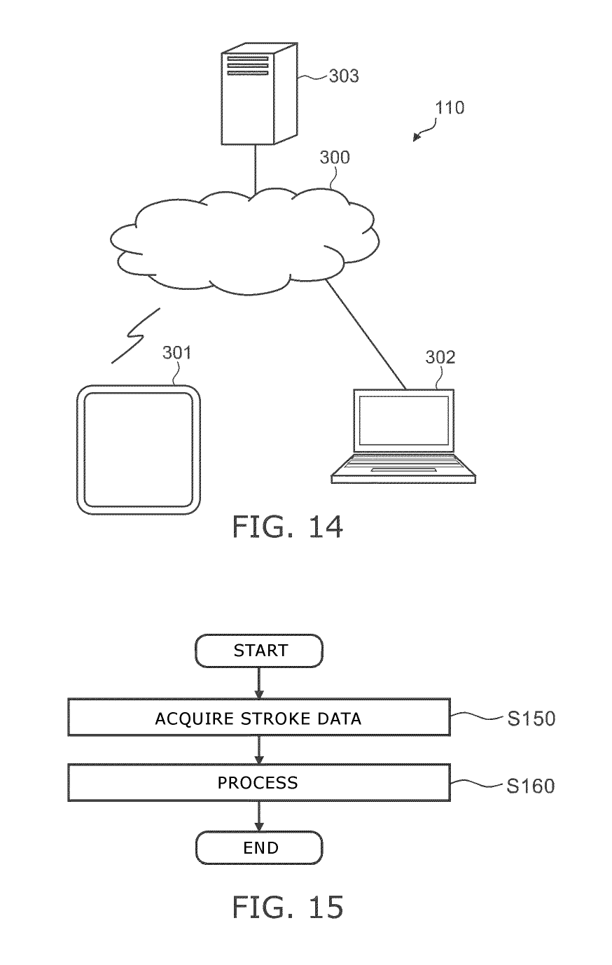

FIG. 14 is a schematic view showing the handwritten document processing device according to the first embodiment.

As shown in FIG. 14, a server 303 is provided on a network 300. The network 300 includes, for example, at least one selected from an intranet and the Internet. A client 301 and a client 302 can communicate with the server 303 via the network 300. The handwritten document processing device 110 according to the embodiment may be formed of such a client and server.

For example, the client 301 is connected to the network 300 via wireless communication. The client 302 is connected to the network 300 via wired communication.

The client 301 and the client 302 are, for example, user devices. The server 303 is provided, for example, on a LAN. For example, an intra-corporate LAN, etc., is used as the LAN. The server 303 may be managed by, for example, an internet service provider, etc. The server 303 may be a user device. The user may provide the functions of the server to other users. Various modifications of the configuration of the handwritten document processing device 110 being dispersed in clients and servers are possible.

FIG. 15 is a flowchart showing the operations of the handwritten document processing device according to the first embodiment.

In the handwritten document processing device 110 as shown in FIG. 15, for example, the multiple sets of stroke data 80 of a handwritten document are acquired (step S150). The operation is implemented by, for example, the input/output unit 10.

Then, processing (e.g., the first processing operation) is implemented (step S160). The processing is implemented by, for example, the processing unit 20. The first processing operation derives the table data 40 based on the multiple sets of stroke data 80 acquired by the input/output unit 10, where the table data 40 includes the first ruled line data 41rd, the second ruled line data 42rd, and the first cell data 45ad including the predetermined shape pattern. The table data 40 is supplied to the input/output unit 10.

In the embodiment, the length in the second direction D2 of the cell shape (the first cell shape 45a) generated based on the first cell data 45ad to correspond to the shape pattern and the inter-ruled line distance (the first inter-ruled line distance L12) along the second direction D2 intersecting the first direction D1 between the first ruled line 41r generated based on the first ruled line data 41rd to extend in the first direction D1 and the second ruled line 42r generated based on the second ruled line data 42rd to extend in the first direction D1 are independently modifiable.

The second processing operation recited above may be implemented in step S160.

### Second Embodiment

The embodiment relates to a handwritten document processing program. The processing described in the first embodiment is implementable based on a program which is software.

The program implements at least a portion of the processing described in the first embodiment.

For example, the handwritten document processing program causes a computer to acquire the multiple sets of stroke data 80 of the handwritten document. The program causes the computer to implement the first processing operation. The first processing operation derives the table data 40 based on the multiple sets of stroke data 80 that is acquired, where the table data 40 includes the first ruled line data 41rd, the second ruled line data 42rd, and the first cell data 45ad including the predetermined shape pattern. The table data 40 is supplied to the input/output unit 10.

In the embodiment, the length in the second direction D2 of the cell shape (the first cell shape 45a) generated based on the first cell data 45ad to correspond to the shape pattern and the inter-ruled line distance (the first inter-ruled line distance L12) along the second direction D2 intersecting the first direction D1 between the first ruled line 41r generated based on the first ruled line data 41rd to extend in the first direction D1 and the second ruled line 42r generated based on the second ruled line data 42rd to extend in the first direction D1 are independently modifiable.

Further, the handwritten document processing program may cause the computer to implement the second processing operation recited above.

The handwritten document processing program according to the embodiment is storable in, for example, a versatile computer system. Effects similar to the effects obtained by the handwritten document processing device 110 according to the embodiment can be obtained by reading the program.

The instructions described in the embodiment are recordable in a recording medium as a program that can be executed by the computer. For example, a magnetic disk (a flexible disk, a hard disk, etc.), an optical disk (CD-ROM, CD-R, CD-RW, DVD-ROM, DVD±R, DVD±RW, etc.), a semiconductor memory, etc., may be used as the recording medium.

The recording medium is readable by a computer or an embedded system. The format of the recording (the storage) of the recording medium is arbitrary.

The computer reads the program from the recording medium and causes the CPU to execute the instructions described in the program based on the program. The operations of the handwritten document processing device 110 according to the embodiment can be implemented. The computer may acquire or read the program via a network when acquiring or reading the program.

The program is installed from the recording medium into, for example, the computer and/or the embedded system. Based on the instructions of the program, the OS (operating system) operating on the computer, database management software, MW (middleware) of the network, etc., may execute a portion of the processing included in the embodiment.

The recording medium according to the embodiment is, for example, independent of the computer or the embedded system. The embodiment is not limited thereto; and the recording medium according to the embodiment also includes, for example, a recording medium that stores or temporarily stores a downloaded program. The download of the program is performed via, for example, a LAN, the Internet, etc.

There may be one or multiple recording media in the embodiment. The processing according to the embodiment may be executed based on the multiple recording media. The configurations of the media included in the recording media according to the embodiment are arbitrary.

The computer or embedded system according to the embodiment executes the processing of the embodiment based on the program stored in the recording medium. The computer or embedded system according to the embodiment may include, for example, one device such as a personal computer, a microcomputer, etc. The computer or embedded system according to the embodiment may include, for example, a system in which multiple devices are connected in a network, etc.

The computer according to the embodiment also may include a personal computer, a processor included in an information processing device, a microcomputer, etc. The computer according to the embodiment includes devices that can realize the functions according to the embodiment by a program.

### Third Embodiment

The embodiment relates to a handwritten document processing method. In the method, for example, the processing described in regard to FIG. 15 is performed. In the handwritten document processing method, the handwritten document processing device 110 described in the first embodiment and modifications of the handwritten document processing device 110 can be used.

According to the embodiments, a handwritten document processing device, a handwritten document processing method, and a handwritten document processing program that convert a handwritten table into easily-usable table data can be provided.

In the specification of the application, “orthogonal,” “perpendicular,” or “parallel” include fluctuation, etc., and include the state of being substantially perpendicular or substantially parallel.

Hereinabove, embodiments of the invention are described with reference to specific examples. However, the invention is not limited to these specific examples. For example, one skilled in the art may similarly practice the invention by appropriately selecting specific configurations of components included in the handwritten document processing device such as the input/output unit, the processing unit, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all handwritten document processing devices, handwritten document processing methods, and handwritten document processing programs practicable by an appropriate design modification by one skilled in the art based on the handwritten document processing devices, handwritten document processing methods, and handwritten document processing programs described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A handwritten document processing device, comprising:
an input/output controller configured to acquire stroke data of a handwritten document; and
a processor configured to derive table data based on the stroke data and supply the table data to the input/output controller, the table data comprising first ruled line data, second ruled line data, and first cell data, the first cell data comprising a shape pattern,
wherein the processor is configure to determine a length in a second direction of a cell shape and an inter-ruled line distance along the second direction between a first ruled line and a second ruled line independently of each other, to generate the first ruled line extending in a first direction based on the first ruled line data, to generate the second ruled line extending in the first direction based on the second ruled line data wherein the second direction intersects the first direction, and to generate the cell shape corresponding to the shape pattern based on the first cell data.

2. The device according to claim 1, wherein the shape pattern comprises at least one selected from a circle, a flattened circle, and a polygon.

3. The device according to claim 1, wherein the shape pattern comprises a quadrilateral.

4. The device according to claim 1, wherein
the cell shape is disposed between the first ruled line and the second ruled line, and
a first distance along the second direction between the first ruled line and a position along the second direction of the cell shape is linked to the inter-ruled line distance.

5. The device according to claim 1, wherein
the cell shape is disposed between the first ruled line and the second ruled line, and
a first distance along the second direction between the first ruled line and a position along the second direction of the cell shape is proportional to the inter-ruled line distance.

6. The device according to claim 1, wherein
the stroke data comprises a first portion, a second portion, and a cell portion, the first portion comprising first stroke data, the second portion comprising second stroke data, the cell portion comprising cell stroke data,
the first ruled line data corresponds to the first portion,
the second ruled line data corresponds to the second portion, and
the first cell data corresponds to the cell portion.

7. The device according to claim 1, wherein the deriving the table data comprises:
shape recognition processing of dividing the stroke data into the first cell data and non-cell data different from the first cell data; and
ruled line derivation processing of deriving the first ruled line data and the second ruled line data from the non-cell data.

8. The device according to claim 1, wherein
the processor is configured to generate the first ruled line extending in the first direction based on the first ruled line data,
to generate the second ruled line extending in the first direction based on the second ruled line data, and
to generat a first arrow extending in the second direction intersecting the first direction based on first arrow data wherein,
a start point portion of the first arrow is positioned between the first ruled line and the second ruled line,
an end point portion of the first arrow is positioned between the start point portion and the second ruled line,
a distance along the second direction between the first ruled line and the start point portion is linked to a distance along the second direction between the first ruled line and the second ruled line, and
a distance along the second direction between the second ruled line and the end point portion is linked to the distance along the second direction between the first ruled line and the second ruled line.

9. A handwritten document processing device, comprising:
an input/output controller configured to acquire stroke data of a handwritten document; and
a processor configured to derive table data based on the stroke data and supply the table data to the input/output controller, the table data comprising first ruled line data, second ruled line data, and first arrow data, wherein the processor is configured
to generate a first ruled line extending in a first direction based on the first ruled data,
to generate a second ruled line extending in the first direction based on the second ruled line data, and
to generate a first arrow extending in a second direction intersecting the first direction based on the first arrow data, wherein
a start point portion of the first arrow is positioned between the first ruled line and the second ruled line,
an end point portion of the first arrow is positioned between the start point portion and the second ruled line,
a distance along the second direction between the first ruled line and the start point portion is linked to a distance along the second direction between the first ruled line and the second ruled line, and
a distance along the second direction between the second ruled line and the end point portion is linked to the distance along the second direction between the first ruled line and the second ruled line.

10. The device according to claim 8, wherein
the table data further comprises third ruled line data and second arrow data, and
the processor is further configured
to generate a third ruled line extending in the first direction based on the third ruled line data, wherein the second ruled line is disposed between the first ruled line and the third ruled line, and
to generate a second arrow extending in the second direction intersecting the first direction based on the second arrow data, wherein
a start point portion of the second arrow is positioned between the first ruled line and the second ruled line,
an end point portion of the second arrow is positioned between the second ruled line and the third ruled line, and
the second arrow intersects the second ruled line.

11. The device according to claim 10, wherein a distance along the second direction between the second ruled line and the start point portion of the second arrow is linked to the distance along the second direction between the first ruled line and the second ruled line.

12. The device according to claim 10, wherein a distance along the second direction between the second ruled line and the end point portion of the second arrow is proportional to the distance along the second direction between the first ruled line and the second ruled line.

13. The device according to claim 8, wherein a distance along the second direction between the second ruled line and the end point portion of the second arrow is linked to a distance along the second direction between the second ruled line and the third ruled line.

14. The device according to claim 8, wherein a distance along the second direction between the second ruled line and the end point portion of the second arrow is proportional to a distance along the second direction between the second ruled line and the third ruled line.

15. The device according to claim 8, wherein
the stroke data comprises an arrow portion, and
the first arrow data corresponds to the arrow portion.

16. The device according to claim 8, wherein a length along the first direction of the end point portion is longer than a length along the first direction of the start point portion.

17. The device according to claim 8, wherein
arrow recognition processing comprises dividing the stroke data into the first arrow data and non-arrow data different from the first arrow data; and
ruled line derivation processing comprises deriving the first ruled line data and the second ruled line data from the non-arrow data.

18. The device according to claim 1, wherein the shape pattern comprises a circle.

19. A handwritten document processing method of a processing device, comprising:
acquiring stroke data of a handwritten document; and
deriving table data based on the stroke data and supplying the table data to the input/output controller, the table data comprising first ruled line data, second ruled line data, and first cell data, the first cell data comprising a shape pattern,
wherein the deriving table data comprises determining a length in a second direction of a cell shape and an inter-ruled line distance along the second direction between a first ruled line and a second ruled line independently of each other, generating the first ruled line extending in a first direction based on the first ruled line data, generating the second ruled line extending in the first direction based on the second ruled line data, wherein the second direction intersects the first direction, and generating the cell shape corresponding to the shape pattern based on the first cell data.

20. A computer readable, non-transitory storage medium comprising a handwritten document processing program, configured to
cause a computer to acquire stroke data of a handwritten document, and
cause the computer to derive table data based on the stroke data and supply the table data to the input/output controller, the table data comprising first ruled line data, second ruled line data, and first cell data, the first cell data comprising a shape pattern, the shape pattern being predetermined,
wherein the deriving table data comprises deteriming a length in a second direction of a cell shape and an inter-ruled line distance along the second direction between a first ruled line and a second ruled line independently of each other, generating the first ruled line extending in a first direction based on the first ruled line data, generating the second ruled line extending in the first direction based on the second ruled line data, wherein the second direction intersects the first direction, and generating the cell shape corresponding to the shape pattern based on the first cell data.
